(19) United States
(12) Patent Application Publication
(10) Pub. No.: US 2008/0182519 A1
(43) Pub. Date: Jul. 31, 2008

(54) Method and System for Robust Single Sideband LO Generation

(76) Inventors: Hesam Amir Aslanzadeh, College Station, TX (US); Alireza Zolfaghari, Irvine, CA (US)

Correspondence Address: MCANDREWS HELD & MALLOY, LTD, 500 WEST MADISON STREET, SUITE 3400, CHICAGO, IL, 60661, US

(21) Appl. No.: 11/668,890

(22) Filed: Jan. 30, 2007

(51) Int. Cl. H04B 1/68

(52) U.S. Cl. 455/47

(57) ABSTRACT

Methods and systems for robust single sideband LO generation are disclosed. Aspects of one method may include generating LO output signals where a VCO may generate a signal that may be used to generate a first pair of signals and a second pair of signals. The first pair of signals, with a frequency of 1.8 GHz, may be 90° out of phase With each other, and the second pair of signals, with a frequency of 800 MHz, may be 90° out of phase with each other. The second pair of signals may be linearly amplified and low-pass filtered. The filtered signals may be mixed with the first pair of signals to generate the LO output signals. A corner frequency for the low-pass filter may be substantially 1.5 times the frequency of a fundamental frequency for the signal to be filtered. Various embodiments of the invention may generate differential output signals, including the LO output signals.

### CROSS-REFERENCE TO RELATED APPLICATIONS/INCORPORATION BY REFERENCE

[Not Applicable]

### FEDERALLY SPONSORED RESEARCH OR DEVELOPMENT

[Not Applicable]

### MICROFICHE/COPYRIGHT REFERENCE

[Not Applicable]

### FIELD OF THE INVENTION

Certain embodiments of the invention relate to wireless communication. More specifically, certain embodiments of the invention relate to a method and system for robust single sideband LO generation.

### BACKGROUND OF THE INVENTION

In some conventional systems, a transmitter may broadcast radio frequency (RF) signals. Generally, RF signals are generated by upconverting baseband signals to intermediate frequency (IF) signals, and then further upconverting the IF signals to RF signals, or directly upconverting from baseband signals to RF signals. The baseband signals may be upconverted to RF signals by using local oscillator (LO) signals that may be at a desired RF carrier frequency.

The baseband signal, or the IF signal, may be mixed with the LO signal to generate the RF signal. However, if the RF signal is amplified with sufficient gain for transmission, and there is enough leakage of the RF signal to the voltage controlled oscillator (VCO) that generates the LO signal, the VCO may lock on to the RF signal. This may be undesirable since the LO signal should be stable at the desired frequency. This may be alleviated by using a LO configuration that outputs a LO signal whose frequency may be substantially different from the VCO signal frequency by mixing the VCO signal with another signal to generate the LO signal. However, the mixing process to generate the LO signal may result in unwanted levels of harmonics and frequency instability with respect to temperature, process, and/or device mismatches.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method for robust single sideband LO generation, substantially as shown in and/or described in connection with at least one of the figures, as set forth more completely in the claims.

Various advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram of an exemplary wireless system, which may be utilized in connection with an embodiment of the invention.

FIG. 2 is a block diagram illustrating an exemplary phase locked loop that may be utilized in connection with an embodiment of the invention.

FIG. 3A is a block diagram of an exemplary local oscillator generator.

FIG. 3B is a block diagram of an exemplary quadrature block, which may be utilized in accordance with an embodiment of the invention.

FIG. 4 is a block diagram of an exemplary robust SSB local oscillator generator, in accordance with an embodiment of the invention.

FIG. 5 is an exemplary flow diagram for generating a robust SSB local oscillator signal, in accordance with an embodiment of the invention.

### DETAILED DESCRIPTION OF THE INVENTION

Certain embodiments of the invention may be found in a method and system for robust single sideband LO generation. Aspects of the method may comprise generating LO output signals. For example, a VCO may generate a signal that may have a frequency of 1.6 GHz. The VCO may be buffered from RC loads by a buffer. The VCO signal may be buffered, and the buffered signal may be non-linearly amplified. The resulting non-linearly amplified signal may be used to generate a first pair of signals that may be substantially 90° out of phase with respect to each other. The first pair of signals may have a frequency of 1.6 GHz.

A second pair of signals that may be substantially 90° out of phase with respect to each other may be generated from the buffered signal, and the second pair of signals may be linearly amplified and low-pass filtered. The filtered signals may have a frequency of 800 MHz. The first pair of signals and the filtered signals may be mixed to generate the LO output signals, where the LO output signals may be used to upconvert, for example, a baseband signal to I and Q channel RF signals. A corner frequency for the low-pass filter may be substantially 1.5 times the frequency of a fundamental frequency for the signal to be filtered. Various embodiments of the invention may generate differential output signals, including the LO output signals.

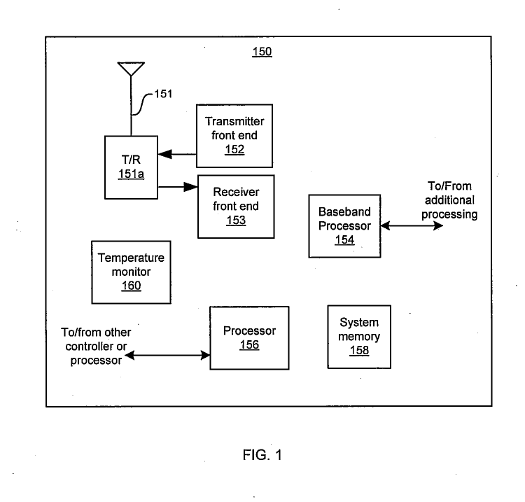

FIG. 1 is a block diagram of an exemplary wireless system, which may be utilized in connection with an embodiment of the invention. Referring to FIG. 1, the wireless system 150 may comprise a transmitting antenna 151, a transmitter/receiver switch 151a, a transmitter front end 152, a receiver front end 153, a baseband processor 154, a processor 156, a system memory 158, and a temperature monitor 160. The transmitter/receiver switch 151 a may comprise suitable circuitry that enables the antenna 151 to be used for both receiving and transmitting signals. The transmitter front end (TFE) 152 may comprise suitable logic, circuitry, and/or code that may be adapted to upconvert a baseband signal directly to an RF signal and to transmit the RF signal via a transmitting antenna 151. The TFE 152 may also be adapted to upconvert a baseband signal to an IF signal, and/or upconvert the IF signal to an RF signal and then transmit the RF signal via the transmitting antenna 151. The TFE 152 may be adapted to execute other functions, for example, filtering the baseband signal, and/or amplifying the baseband signal.

The receiver front end (RFE) 153 may comprise suitable logic, circuitry, and/or code that may be adapted to downconvert a RF signal directly to a baseband signal for further processing. The RFE 153 may also be adapted to downconvert a RF signal to an IF signal, and/or downconvert the IF signal to a baseband signal for further processing. The RFE 153 may be adapted to execute other functions, for example, filtering the baseband signal, and/or amplifying the baseband signal.

The baseband processor 154 may comprise suitable logic, circuitry, and/or code that may be adapted to process baseband signals, for example, convert a digital signal to an analog signal, and/or vice-versa. The processor 156 may be any suitable processor or controller such as a CPU or DSP, or any type of integrated circuit processor. The processor 156 may comprise suitable logic, circuitry, and/or code that may be adapted to control the operations of the TFE 152 and/or the baseband processor 154. For example, the processor 156 may be utilized to update and/or modify programmable parameters and/or values in a plurality of components, devices, and/or processing elements in the TFE 152 and/or the baseband processor 154. Control and/or data information, which may include the programmable parameters, may be transferred from at least one controller and/or processor, which may be part of the wireless system 150, to the processor 156. Similarly, the processor 156 may be adapted to transfer control and/or data information, which may include the programmable parameters, to at least one controller and/or processor, which may be part of the wireless system 150.

The processor 156 may utilize the received control and/or data information, which may comprise the programmable parameters, to determine an operating mode of the TFE 152. For example, the processor 156 may be utilized to select a specific frequency for a local oscillator, or a specific gain for a variable gain amplifier. Moreover, the specific frequency selected and/or parameters needed to calculate the specific frequency, and/or the specific gain value and/or the parameters needed to calculate the specific gain, may be stored in the system memory 158 via the processor 156. The information stored in system memory 158 may be transferred to the TFE 152 from the system memory 158 via the processor 156. The system memory 158 may comprise suitable logic, circuitry, and/or code that may be adapted to store a plurality of control and/or data information, including parameters needed to calculate frequencies and/or gain, and/or the frequency value and/or gain value.

The temperature monitor 160 may comprise suitable logic, circuitry, and/or code that may be adapted to determine temperature at a measuring point, for example, in the wireless system 150. The temperature may be determined, for example, in degrees Centigrade. The temperature monitoring block 160 may communicate information to, for example, the processor 156. The processor 156 may use the temperature information, for example, to determine gain compensation at different temperatures for different devices.

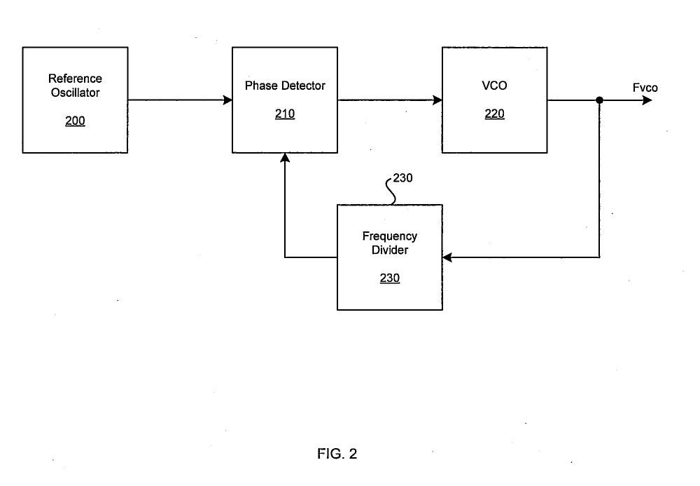

FIG. 2 is a block diagram illustrating an exemplary phase locked loop that may be utilized in connection with an embodiment of the invention. Referring to FIG. 2, there is shown a reference oscillator 200, a phase detector 210, a voltage controlled oscillator (VCO) 220, and a frequency divider 230.

The reference oscillator 210 may comprise suitable logic and/or circuitry that may be adapted to generate a signal of a fixed frequency. The signal may be utilized as a reference signal for a phased lock loop circuit. This signal may be a low frequency signal on the order of, for example, megahertz or tens of megahertz. The phase detector 210 may comprise suitable logic and/or circuitry that may be adapted to compare two signals and generate an output voltage that may indicate whether the two signals have the same frequency, or whether the frequency of one signal is larger than the frequency of the other signal.

The voltage controlled oscillator 220 may comprise suitable logic and/or circuitry that may be adapted to generate a signal that may vary in frequency according to an input control voltage. The input control voltage may be communicated by the phase detector 210. The voltage controlled oscillator 220 may be utilized to generate RF carrier signals that may be utilized to upconvert baseband or IF signals to RF signals.

The frequency divider 230 may comprise suitable logic and/or circuitry that may be adapted to reduce the frequency of an input signal, for example, the output signal, F_{VCO}, from the voltage controlled oscillator 220, where the reduction may be by an integer factor or a non-integer factor. The output of the frequency divider 230 may be communicated to the phase detector 210. The phase detector 210 may compare the output of the frequency divider 230 and the output of the reference oscillator 200. The phase detector 210 may generate suitable voltage to communicate to the voltage controlled oscillator 220 that may indicate whether to increase the frequency of the output signal, F_{VCO}, decrease the frequency of the output signal, F_{VCO}, or keep the frequency of the output signal, F_{VCO}, at the same frequency.

In operation, the frequency divider 230 may divide the output signal, F_{VCO}, from the voltage controlled oscillator 220 to generate a signal that may be the same frequency as the reference signal generated by the reference oscillator 100. However, if the output signal, F_{VCO}, is not quite a desired multiple of the reference signal generated by the reference oscillator 200, or if it is an incorrect multiple of the reference signal generated by the reference oscillator 200, the phase detector 210 may generate a control input voltage. The control input voltage may be communicated to the voltage controlled oscillator 220 to drive the frequency of the output signal, F_{VCO}, to the desired frequency value.

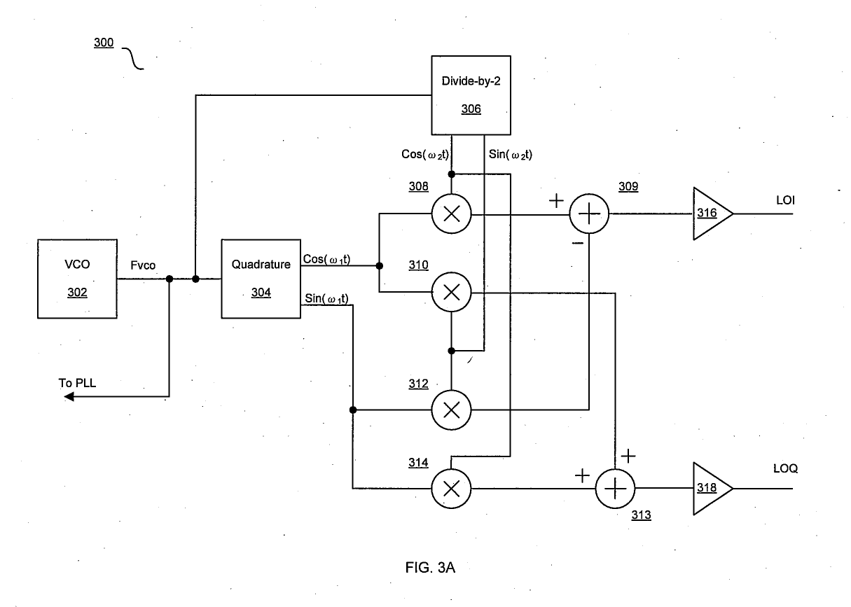

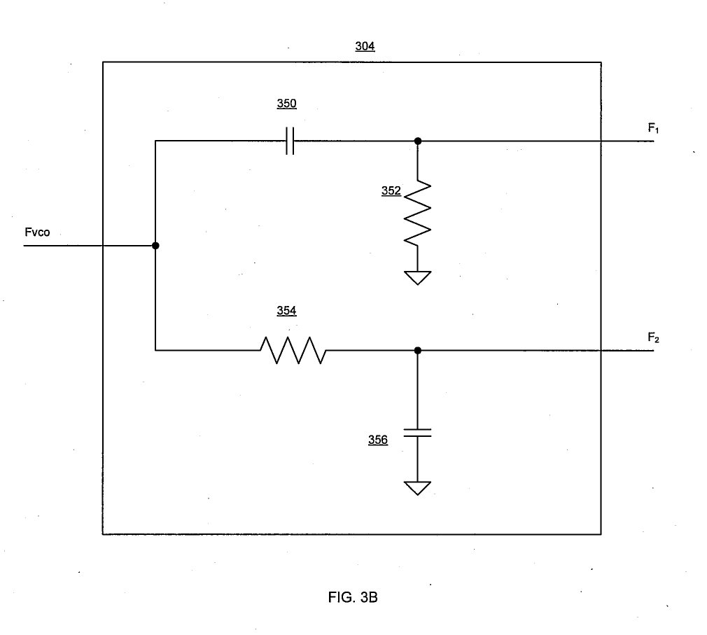

FIG. 3A is a block diagram of an exemplary local oscillator generator. Referring to FIG. 3A, there is shown a LO generator block 300 that may comprise a VCO 302, the quadrature block 304, the divide-by-2 block 306, the mixers 308, 310, 312, and 314, and the buffers 316 and 318. There is also shown combiner blocks 309 and 313. The VCO 302 may be similar to the VCO 220. The quadrature block 304 may comprise suitable circuitry that may enable receiving an input signal and generating two signals that may be 90° out of phase with respect to each other. These signals may be referred to, for example, as cos(ω₁t) and sin(ω₁t). The divide-by-2 block 306 may comprise suitable circuitry and/or logic that may enable receiving an input signal and generating two signals whose frequencies may be ½ of the input signal frequency, and where the two signals may be out of phase by 90° with respect to each other. These signals may be referred to, for example, as cos(ω₂t) and sin(ω₂t).

The mixers 308, 310, 312, and 314 may comprise suitable circuitry that may be used to enable mixing of two signals. The outputs of the mixers 308, 310, 312, and 314 may be, for example, current outputs. The combiner blocks 309 and 313 are shown for clarity. If the mixers 308, 310, 312, and 314 provide current as output, then the combiner blocks 309 and 313 may sum the output current at the node where the outputs are joined together. Otherwise, if the mixers 308, 310, 312, and 314 provide a voltage output, the combiner blocks 309 and 313 may comprise suitable circuitry that may enable adding or subtracting the voltage signals. The buffers 316 and 318 may comprise suitable circuitry that may be used to provide amplification for the outputs of the mixers 308 and 312, and 310 and 314, respectively. The buffers 316 and 318 may also comprise LC circuitry that may be used to attenuate a lower sideband from the output of the mixers and/or to attenuate signals due to harmonics from, for example, the divide-by-2 block 306.

In operation, the signal F_{VCO} may be generated by the VCO 302. The signal F_{VCO} may be communicated to the quadrature block 304, the divide-by-2 block 306, and also fed back to, for example, a frequency divider of a PLL that the VCO 302 may be a part of. The quadrature block 304 may generate the output signals cos(ω₁t) and sin(ω₁t), and the divide-by-2 block 306 may generate the output signals cos(ω₂t) and sin(ω₂t). The mixer 308 may mix the signals cos(ω₁t) and cos(ω₂t), and the resulting current output may be described by:

cos(ω₁t)*cos(ω₂t)=(1/2)((cos(ω₁+ω₂)t)+(cos(ω₁−ω₂)t)) [1]

The mixer 312 may mix the signals sin(ω₁t) and sin(ω₂t), and the resulting signal may be inverted, which may be described by:

$$\begin{matrix}- sin ( {ω}_{1} t ) * sin ( {ω}_{2} t ) = - ( 1 / 2 ) ( ( cos ( {ω}_{1} - {ω}_{2} ) t ) - \\ ( cos ( {ω}_{1} + {ω}_{2} ) t ) ) \\ = ( 1 / 2 ) ( ( cos ( {ω}_{1} + {ω}_{2} ) t ) - ( cos ( {ω}_{1} - {ω}_{2} ) t ) )\end{matrix} \qquad [ 2 ]$$

Accordingly, a result of combining of the output currents of the mixers 308 and 312 may not have the cos(ω₁−ω₂)t term, while the cos(ω₁+ω₂)t terms may remain. Hence, the lower sideband may be canceled and the upper sideband may remain, and the upper sideband may have a frequency that is 1.5 times the frequency of the signal F_{VCO}. The mixers 308 and 312 may generate a single sideband signal.

Similarly, the mixer 310 may mix the signals cos(ω₁t) and sin(ω₂t), and the resulting output may be described by:

cos(ω₁t)*sin(ω₂t)=(1/2)((sin(ω₁+ω₂)t)−(sin(ω₁−ω₂)t)) [3]

The mixer 314 may mix the signals sin(ω₁t) and cos(ω₂t), which may be described by:

sin(ω₁t)*cos(ω₂t)=(1/2)((sin(ω₁−ω₂)t)+(sin(ω₁+ω₂)t)) [4]

Accordingly, a result of combining the output currents of the mixers 310 and 314 may not have the sin(ω₁−ω₂)t term, while the sin(ω₁+ω₂)t terms may remain. Hence, the lower sideband may be removed and the upper sideband may remain, and the upper sideband may have a frequency that is 1.5 times the frequency of the signal F_{VCO}. The mixers 310 and 314 may generate a single sideband signal.

The upper sideband signals cos(ω₁+ω₂)t and sin(ω₁+ω₂)t may be buffered by the buffers 316 and 318, respectively, and the outputs of the buffers 316 and 318 may be referred to as the signals LOI and LOQ, respectively. The signals LOI and LOQ, which may be 90° out of phase with respect to each other, may be used to upconvert analog baseband signals to RF frequencies to generate I and Q RF channels for transmission.

FIG. 3B is a block diagram of an exemplary quadrature block, which may be utilized in accordance with an embodiment of the invention. Referring to FIG. 3B, there is shown the quadrature block 304, which may comprise the capacitors 350 and 356, and the resistors 352 and 354. The quadrature block 304 may receive an input signal F_{VCO} and generate two output signals F₁ and F₂. The capacitor 350 and the resistor 352 may form a high-pass filter whose output may be the signal F₁. The phase delay for the output signal F₁ with respect to the input signal F_{VCO} may be arctan(f₀/f). The resistor 354 and the capacitor 356 may form a low-pass filter whose output may be the signal F₂. The phase delay for the output signal F₂ with respect to the input signal F_{VCO} may be −arctan(f₀/f). The turnover frequency f₀ may be dependent on the resistance and capacitance values of the resistor and capacitor in the filter, respectively.

Accordingly, by appropriately choosing the values for the capacitors 350 and 356, and the resistors 352 and 354, a phase difference of 90° may be introduced between the two output signals F₁ and F₂ at a desired frequency. For example, the capacitor 350 and the capacitor 356 may have the same capacitance values, and the resistor 352 and the resistor 354 may have the same resistance values. Accordingly, the capacitor 350 and the resistor 352 may introduce a phase difference of 45° between the output signal F₁ and the input signal F_{VCO}. Similarly, the resistor 354 and the capacitor 356 may introduce a phase difference of −45° between the output signal F₂ and the input signal F_{VCO}. Accordingly, there may be a phase difference of 90° between the output signals F₁ and F₂.

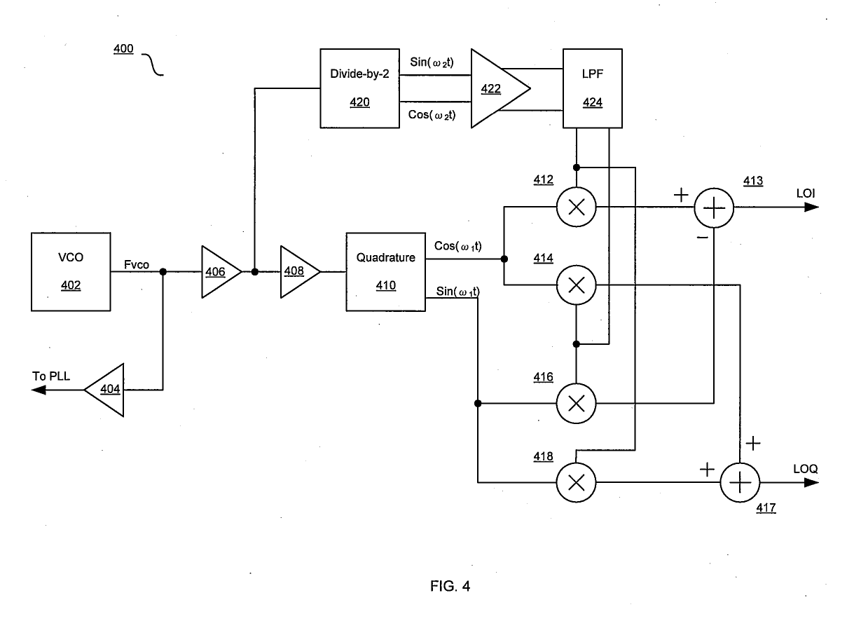

FIG. 4 is a block diagram of an exemplary robust SSB local oscillator generator, in accordance with an embodiment of the invention. Referring to FIG. 4, there is shown a LO generator block 400 that may comprise a VCO 402, buffers 404, 406, and 408, a quadrature block 410, mixers 412, 414, 416, and 418, a divide-by-2 block 420, a linear amplifier 422, and a low-pass filter (LPF) 424. The VCO 402 may be similar to the VCO 220, the quadrature block 410 may be similar to the quadrature block 304, and the divide-by-2 block 420 may be similar to the divide-by-2 block 306. The mixers 412, 414, 416, and 418 may be similar to the mixer 308, 310, 312, or 314. There is also shown the combiner blocks 413 and 417. For simplicity, the mixers 412, 414, 416, and 418 may be described as outputting current. Accordingly, the combiner blocks 413 may be implemented, for example, by coupling the outputs of the mixers 412 and 416. Similarly, the combiner block 417 may be implemented, for example, by coupling the outputs of the mixers 414 and 418. Accordingly, the output currents from the mixers 412 and 416 may be combined, and the output currents from the mixers 414 and 418 may be combined.

The buffers 404 and 406 may comprise suitable circuitry that may be used to buffer the output of the VCO from output load due to traces and/or provide gain. The buffer 406 may be, for example, a resistive feedback inverting buffer that may limit backward isolation of an output signal. The buffer 408 may, for example, provide amplification to an output of the buffer 406. In an embodiment of the invention, the buffer 408 may operate in the saturation region, which may generate, for example, a digital signal that may be used to turn on and off portions of the mixers 412, 414, 416, and 418. While the buffer 408 may generate a digital signal, the invention need not be so limited. For example, the buffer 408 may have a high gain, but not operate in the saturation region, and accordingly, the output of the buffer 408 may be analog. The amplifier 422 may provide linear gain to, for example, two input signals to generate two output signals. The LPF 424 may enable attenuation of harmonics generated, for example, by the divide-by-2 block 422.

In operation, the VCO 402 may generate the signal F_{VCO}, and the signal F_{VCO} may be communicated to the buffers 404 and 406. The buffer 406 may feed back its output signal to, for example, a frequency divider of a PLL that the VCO 402 may be a part of. The buffer 406 may communicate its output to the buffer 408 and to the divide-by-2 block 420. The amplified signal of the buffer 408 may be communicated to the quadrature block 410. The quadrature block 408 may generate two signals where the two signals may be 900 out of phase with respect to each other. These signals may be referred to as, for example, cos(ω₁t) and sin(ω₁th).

The signals cos(ω₁t) and sin(ω₁t) may be communicated to the mixers 412, 414, 416, and 418. The quadrature block 410, which may be, for example, a passive device, may attenuate by 3 dB each of its output signals cos(ω₁t) and sin(ω₁t) with respect to the input signal to the quadrature block 410. Accordingly, the gain of the buffer 408 may help offset the attenuation by the quadrature block 410. The gain of the buffer 408 may also help to make the signals cos(ω₁t) and sin(ω₁t) less sensitive to component variation with respect to temperature, process variation, and device mismatch.

The divide-by-2 block 420 may generate two signals whose frequencies may be ½ of the input signal frequency, and where the two signals may be out of phase by 90° with respect to each other. These signals may be referred to, for example, as cos(ω₂t) and sin(ω₂t). The signals cos(ω₂t) and sin(ω₂t) may be communicated to the amplifier 422, and the amplified signals cos(ω₂t) and sin(ω₂t) may be communicated to the LPF 424. The amplified signals cos(ω₂t) and sin(ω₂t) may be filtered to attenuate harmonics of the frequency ω₂ that may have been generated by the divide-by-2 block 420. The outputs of the LPF 424 may be communicated to the mixers 412, 414, 416, and 418.

The outputs of the mixers 412 and 416, as described by the equations [1] and [2], may be combined to generate an upper sideband signal having 1.5 times the frequency of the signal F_{VCO}, and this upper sideband signal may be referred to as the signal LOI. Similarly, the outputs of the mixers 414 and 418, as described by the equations [3] and [4], may be combined to generate an upper sideband signal having 1.5 times the frequency of the signal F_{VCO}, and this upper sideband signal may be referred to as the signal LOQ. Accordingly, the mixers 412 and 416 may generate a single sideband signal, and the mixers 414 and 418 may generate a single sideband signal. The signals LOI and LOQ, which may be 90° out of phase with respect to each other, may be used to upconvert analog baseband signals to RF frequencies to generate I and Q RF channels for transmission.

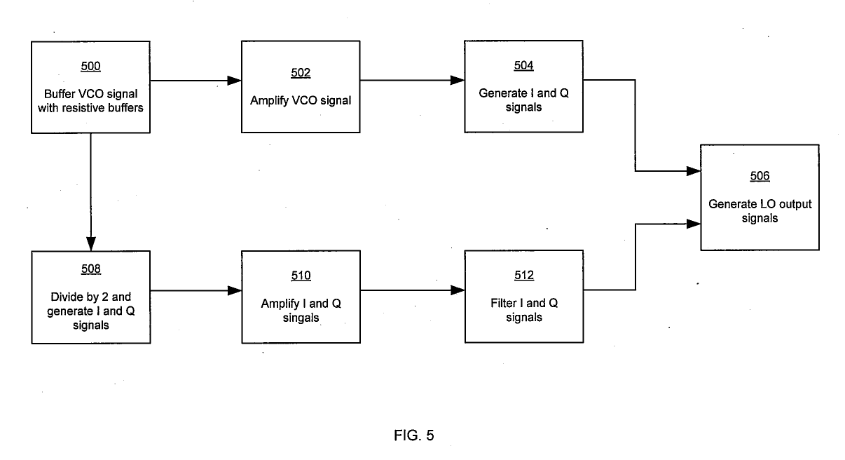

FIG. 5 is an exemplary flow diagram for generating a robust SSB local oscillator signal, in accordance with an embodiment of the invention. Referring to FIG. 5, there is shown steps 500 to 512. In step 500, the VCO 402 may output the signal F_{VCO}, which may be, for example, at a desired frequency. The desired frequency may be 2/3 of a RF carrier frequency. The signal F_{VCO} may be buffered by the buffers 404 and 406. The output of the buffer 404 may be fed back to, for example, the frequency divider 230. The output of the buffer 406 may be communicated to, for example, the buffer 410 and the divide-by-2 block 420. The next step may be steps 502 and 508.

In step 502, the output of the buffer 406 may be amplified by the buffer 408. The buffer 408 may provide a high gain, where the gain may be non-linear. In step 504, the output of the buffer 408 may be communicated to the quadrature block 410. The quadrature block 410 may generate two output signals cos(ω₁t) and sin(ω₁t), where the two output signals cos(ω₁t) and sin(ω₁t) may be 90° out of phase with respect to each other. The frequency of the signals cos(ω₁t) and sin(ω₁t) may be similar to the frequency of the signal F_{VCO}. The two output signals cos(ω₁t) and sin(ω₁t) may be communicated to the mixers 412, 414, 416, and 418. The next step may be step 506, which is described later.

In step 508, the output of the buffer 406 may be communicated to the divide-by-2 block 420. The divide-by-2 block 420 may generate two output signals A cos(ω₂t) and B sin(ω₂t) whose frequencies may be one-half of the input signal frequency. Accordingly, the frequency ω₂ may be ⅓ the RF carrier frequency. The amplitudes A and B may be generally equal to each other. The output signals A cos(ω₁t) and B sin(ω₁t) may be 90° out of phase with respect to each other. The output signals A cos(ω₁t) and B sin(ω₁t) of the divide-by-2 block 420 may be communicated to the amplifier 422. In step 510, the amplifier 422 may linearly amplify the signals A cos(ω₁t) and B sin(ω₁t) to generate output signals GA cos(ω₁t) and GB sin(ω₁t).

In step 512, the amplified signals may be communicated to the LPF 424, which may attenuate undesired frequencies. For example, the undesired frequencies may be harmonics of the fundamental frequency of ω₂ that may have been introduced by the divide-by-2 block 420. In an embodiment of the invention, a corner frequency of the LPF 424 may be set to, for example, 1.5 times the fundamental frequency of ω₂. The output signals of the LPF 424 may be communicated to the mixers 412, 414, 416, and 418. The next step may be step 506.

In step 506, the mixers 412, 414, 416, and 418 may mix the signals from the quadrature block 410 and the signals from the LPF 424. The output of the mixer 412 may be combined to the output of the mixer 416 to generate the signal LOI at an RF carrier frequency that may be one and one-half times the frequency of the signal F_{VCO}. Similarly, the output of the mixer 414 may be combined to the output of the mixer 418 to generate the signal LOQ at an RF carrier frequency that may be one and one-half times the frequency of the signal F_{VCO}. The signals LOI and LOQ may be used to upconvert a baseband signal or an IF signal to radio frequency.

In accordance with an embodiment of the invention, aspects of an exemplary system may comprise a LO generator block 400 that enables generation LO output signals. The LO generator block 400 may comprise a non-linear amplifier, such as, for example, the buffer 408 that enables amplification of an input signal. The output of the buffer 408 may be communicated to the quadrature block 410, which may generate a first pair of signals that may be substantially 90° out of phase with respect to each other. The LO generator block 400 may comprise the divide-by-2 block 420 that may enable generation of a second pair of signals that may be substantially 90° out of phase with respect to each other. The second pair of signals may be communicated to the linear amplifier 422. The outputs of the linear amplifier 422 may be communicated to the LPF 424 for filtering. The outputs of the LPF 424 and the quadrature block 410 may be mixed by the mixers 412, 414, 416, and 418 to generate the single sideband LO signals.

The LO output signals may be used, for example, to generate I channel RF signals and Q channel RF signals by appropriately mixing with, for example, baseband signals. The VCO 402 may provide a VCO signal that may be buffered by the buffer 406 from RC loads, such as, for example, the RC loads of the divide-by-2 block 420. The output of the buffer 406 may be communicated to the buffer 408 and the divide-by-2 block 420. The VCO signal may have a frequency of, for example, 1.6 GHz. Accordingly, the output signals of the quadrature block may also have a frequency of 1.6 GHz. The divide-by-2 block 420 may generate signals that may have a frequency of 800 MHz, and which may be 90° out of phase with respect to each other.

The characteristics of the LPF 424 may be design dependent. An embodiment of the invention may have a corner frequency for the LPF 424 that may substantially be 1.5 times a fundamental frequency. For example, if the LPF 424 is used with a signal that has a fundamental frequency of 800 MHz, the corner frequency may be 1.2 GHz. Various embodiments of the invention may also generate differential signals as outputs of the various blocks. For example, the outputs of the mixers 412, 414, 416, and 418 may be differential. Additionally, other embodiment of the invention may generate differential signals by the buffers 406 and 408, the quadrature block 410, the divide-by-2 block 420, the amplifier 422, and/or the LPF 424.

Another embodiment of the invention may provide a machine-readable storage, having stored thereon, a computer program having at least one code section executable by a machine, thereby causing the machine to perform the steps as described above for robust single sideband LO generation.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will comprise all embodiments falling within the scope of the appended claims.

What is claimed is:

1. A method for wireless communication, the method comprising:
non-linearly amplifying an input signal within a chip;
generating first pair of signals that are substantially 90° out of phase with respect to each other from said non-linearly amplified input signal;
linearly amplifying a second pair of signals derived from said input signal that are substantially 90° out of phase with respect to each other; and
low-pass filtering said linearly amplified second pair of signals.

2. The method according to claim 1, comprising generating LO output signals from said first pair of signals and said filtered second pair of signals.

3. The method according to claim 2, wherein a first of said LO output signals is used for generating I channel RF signals and a second of said LO output signals is used for generating Q channel RF signals.

4. The method according to claim 2, wherein said LO output signals are differential signals.

5. The method according to claim 1, wherein a frequency of said input signal is 1.6 GHz.

6. The method according to claim 1, wherein said first pair of signals have a frequency of 1.6 GHz.

7. The method according to claim 1, wherein said second pair of signals have a frequency of 800 MHz.

8. The method according to claim 1, wherein said input signal is derived from a VCO output signal.

9. The method according to claim 8, comprising isolating said VCO from RC loads by a buffer.

10. The method according to claim 1, wherein a corner frequency used for said low-pass filtering is substantially 1.5 times the frequency of a fundamental frequency of said linearly amplified second pair of signals.

11. A system for wireless communication, the system comprising:
a non-linear amplifier that enables amplification of an input signal within a chip;
circuitry that enables generation of a first pair of signals that are substantially 90° out of phase with respect to each other from said non-linearly amplified input signal;
at least one linear amplifier that enables linear amplification of a second pair of signals, derived from said input signal, which are substantially 90° out of phase with respect to each other; and
at least one low-pass filter that enables filtering of said linearly amplified second pair of signals.

12. The system according to claim 11, comprising a plurality of mixers that enable single-sideband mixing of said first pair of signals and said filtered said second pair of signals to generate LO output signals.

13. The system according to claim 12, wherein a first of said LO output signals is used for generating I channel RF signals and a second of said LO output signals is used for generating Q channel RF signals.

14. The system according to claim 12, wherein said LO output signals are differential signals.

15. The system according to claim 11, wherein a frequency of said input signal is 1.6 GHz.

16. The system according to claim 11, wherein said first pair of signals have a frequency of 1.6 GHz.

17. The system according to claim 11, wherein said second pair of signals have a frequency of 800 MHz.

18. The system according to claim 11, comprising a VCO that generates an output signal from which said input signal is derived.

19. The system according to claim 18, comprising isolating said VCO from RC loads by a buffer.

20. The system according to claim 11, wherein a corner frequency for said at least one low-pass filter is substantially 1.5 times a fundamental frequency for said linearly amplified second pair of signals.

21. The system according to claim 11, wherein said at least one linear amplifier is an inverting amplifier.

22. The system according to claim 11, wherein said non-linear amplifier is an inverting amplifier.
